(19) United States
(12) Patent Application Publication
(10) Pub. No.: US 2016/0041293 A1
(43) Pub. Date: Feb. 11, 2016

(54) Method and Apparatus for Magnetic Ranging While Rotating

(71) Applicant: Schlumberger Technology Corporation, Sugar Land, TX (US)

(72) Inventors: Karim Boudah, Katy, TX (US); Alois Jerabek, Houston, TX (US); Miguel Pabon, Katy, TX (US)

(21) Appl. No.: 14/454,500

(22) Filed: Aug. 7, 2014

(51) Int. Cl. G01V 3/26

(52) U.S. Cl. CPC G01V 3/26

(57) ABSTRACT

A method for magnetic ranging includes rotating a drilling tool in a drilling well in sensory range of an AC ranging signal emanating from a target well. The drilling tool includes a magnetic field sensor rotatably coupled thereto. The magnetic field sensor obtains a plurality of magnetic field measurements while rotating. The magnetic field measurements are mathematically back-rotated to obtain back-rotated magnetic field measurements which are in turn processed to obtain a measurement of the AC magnetic ranging signal emanating from the target well. The AC magnetic ranging signal is then processed to compute at least one of a distance and a direction from the drilling well to the target well.

### CROSS REFERENCE TO RELATED APPLICATIONS

None.

### FIELD OF THE INVENTION

Disclosed embodiments relate generally to magnetic ranging methods and more particularly to methods for magnetic ranging to an AC magnetic field while drilling (i.e., while the drill string is rotating).

### BACKGROUND INFORMATION

In various well drilling operations it is desirable to estimate the location of a nearby wellbore. Examples of such operations include well intercept, well avoidance, well twinning, and relief well drilling operations.

Various active magnetic ranging techniques are known in the oil field services industry, including both AC and DC techniques. An AC magnetic source may also be deployed in the drilling well and the corresponding magnetic field measured in the target. AC magnetic ranging techniques commonly employ an AC magnetic source deployed in the target well. Alternatively, an AC secondary electrical current may be induced in the target wellbore casing string, e.g., via inducing an AC voltage across an insulative gap in the drill string located in the drilling wellbore. The secondary current in the target wellbore casing string further induces a magnetic field that may be measured in the drilling wellbore and used to estimate the location of the target.

While such techniques may be serviceable, they require drilling to be halted and the drill string to be held stationary in the drilling well while each magnetic survey is obtained. Moreover, techniques in which a secondary electrical current may be induced in the target wellbore casing string commonly may require measurements to be made at three or more distinct tool face angles. Such magnetic ranging operations therefore tend to be costly and time consuming There is a need in the art for a method for making magnetic ranging measurements while drilling (i.e., while rotating the drill string) so as to improve the efficiency of drilling operations employing magnetic ranging.

### SUMMARY

A method for magnetic ranging is disclosed. A downhole drilling tool is rotated in a drilling well in sensory range of magnetic flux emanating from a target well. The downhole tool includes a magnetic field sensor rotatably coupled to the tool. The magnetic field sensor obtains a plurality of magnetic field measurements while rotating. The magnetic field measurements are mathematically back-rotated to obtain back-rotated magnetic field measurements which are in turn processed to obtain a measurement of the AC magnetic ranging signal emanating from the target well. The AC magnetic ranging signal is then processed to compute at least one of a distance and a direction from the drilling well to the target well.

The disclosed embodiments may provide various technical advantages. In particular, the disclosed methods may enable magnetic ranging measurements to be acquired and processed while rotating the magnetic field sensors in the drilling well. The measurements may therefore be acquired and processed while drilling. Moreover, in certain embodiments the sonde error may be removed from the measurements in real time while drilling.

The disclosed methodology may also improve ranging accuracy since it tends to be insensitive to variations in the rotation rate (as the magnetic field measurements are mathematically back-rotated while drilling). Moreover the disclosed methodology does not require bulk computer processing or the use of complex transformations such as a fast Fourier transform (FFT) and may therefore be implemented on a conventional downhole controller or low-power processor. The disclosed methodology may also be utilized for both single entry ranging operations (in which only the drilling well is accessed) and dual entry ranging operations (in which both the drilling well in the target well are accessed).

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts one example of a conventional drilling rig on which disclosed methods may be utilized.

FIG. 2 depicts a lower BHA portion of a drill string on which disclosed methods may be utilized.

FIG. 3 depicts an analog circuit 100 for separating various components of the measured magnetic field.

FIGS. 4 and 5 depict circuits for phase sensitive detection and analog to digital conversion of the AC ranging signal and the measured magnetic field.

FIGS. 6A and 6B depict flow charts of disclosed method embodiments.

FIG. 7 depicts one example of a magnetic field amplitude spectrum, including side bands, obtained during drill string rotation.

FIG. 8 depicts one example of a magnetic field amplitude spectrum obtained after application of an inverse toolface rotation matrix to the magnetometer output.

FIG. 9 depicts a block diagram of one example technique for processing the decoupled rotating ranging signals.

FIG. 10 depicts one example of a magnetic field amplitude spectrum obtained after applying the first low pass filter in FIG. 9.

FIG. 11 depicts a block diagram of another disclosed method embodiment.

### DETAILED DESCRIPTION

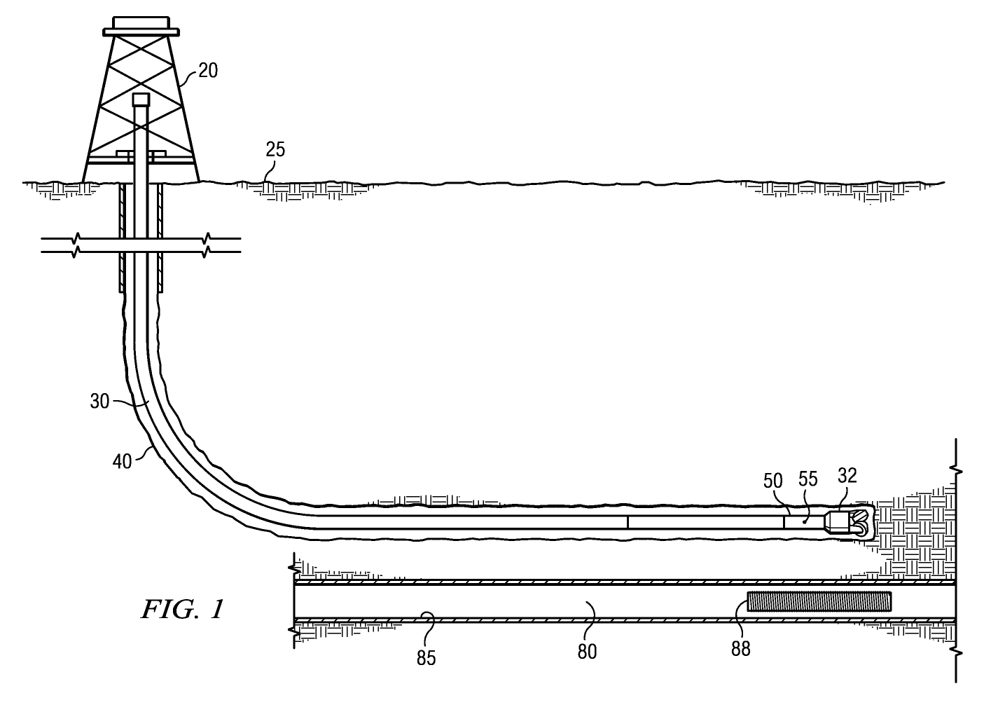

FIG. 1 depicts a drilling rig 20 suitable for using various method embodiments disclosed herein. The rig may be positioned over an oil or gas formation (not shown) disposed below the surface of the earth 25. The rig 20 may include a derrick and a hoisting apparatus for raising and lowering a drill string 30, which, as shown, extends into wellbore 40 and includes a drill bit 32 and a sensor sub 52 including one or more magnetic field sensors (e.g., such as a measurement while drilling tool or the iPZIG® tool available from PathFinder®, A Schlumberger Company, Katy, Tex., USA). Drill string 30 may further include a downhole drilling motor, a steering tool such as a rotary steerable tool, a downhole telemetry system, and one or more MWD or LWD tools including various sensors for sensing downhole characteristics of the borehole and the surrounding formation. The disclosed embodiments are not limited in these regards.

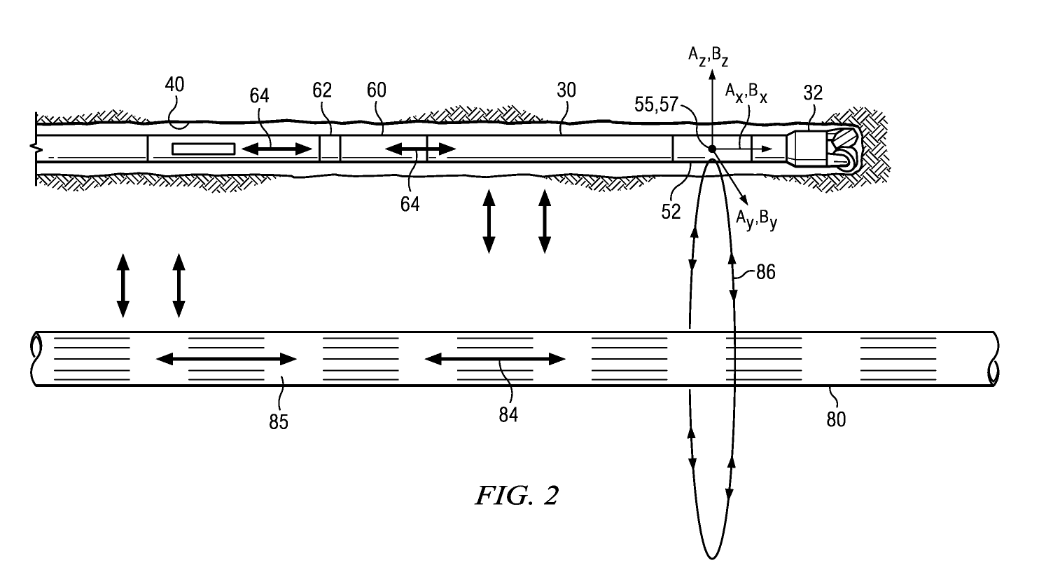

FIG. 1 further depicts a well twinning operation, such as a steam assisted gravity drainage (SAGD) operation, in which various disclosed method embodiments may be utilized. Common SAGD well twinning operations require a horizontal twin well 40 to be drilled a substantially fixed distance above a horizontal portion of a target wellbore 80 (e.g., not deviating more than about 1 meter up or down or to the left or right of the target). In the depicted embodiment the target well 80 is drilled first, for example, using conventional directional drilling and MWD techniques. The target wellbore 80 may include a casing string 85 deployed therein and may be magnetized, for example, via deploying a magnetic source 88 such as an AC electromagnet in the wellbore. It will be understood that the depicted magnetic source is optional and that the magnetic field in the target well may alternatively be induced as described in more detail with respect to FIG. 2. Magnetic field measurements made while the drill string 30 rotates in the drilling well 40 (e.g., at sensor sub 52) may then be used to determine a relative distance and direction from the drilling well 40 to the target well 30 (as described in more detail below).

It will be understood by those of ordinary skill in the art that the deployment illustrated on FIG. 1 is merely an example. For example, while FIG. 1 depicts a SAGD operation, the disclosed embodiments are in no way limited to SAGD or other well twinning operations, but may be used in substantially any drilling operation in which it is desirable to determine the relative location of the drilling well with respect to an offset well. Such operations may be performed onshore (as depicted) or offshore.

With continued reference to FIG. 1, it will be understood that the disclosed embodiments are not limited to the use of a near bit sensor sub (as depicted). In alternative embodiments, the magnetic field sensors may be deployed higher up in the BHA, for example, in a rotary steerable tool (or even higher BHA, e.g., above the current generating tool 60 depicted on FIG. 2). The disclosed embodiments are not limited in this regard.

FIG. 2 depicts the lower bottom hole assembly (BHA) portion of drill string 30. In the depicted example, the BHA further includes an electrical current generating tool 60. The electric current generating tool 60 may include substantially any suitable downhole tool, such as one of Schlumberger's EM telemetry tools. In the depicted embodiment, the electric current generating tool 60 includes an electrically insulating gap 62 across which an AC voltage may be applied to cause electric current 64 to flow along the length of the drill collar. It should be understood that the electric current generating tool 60 may use substantially any power supply configuration capable of generating the current 64 in the drill collar. The applied voltage may be an alternating (AC) voltage operating, for example, in a frequency range from about 0.1 to about 20 Hz.

When the drilling well 40 is in close proximity with the target well 80 (e.g., within about 10 meters), a corresponding electric current may be induced in the target well. For example, in the depicted embodiment, applying an AC voltage across the insulating gap 62 causes an electrical alternating current to flow out into the formation to the target well 80. The electrically conductive casing 85 in the target well 80 provides a path of low resistance which may support an axial alternating current 84 in the target. This alternating current 84 in the target well 80 in turn induces an alternating magnetic field 86 in the formation that is proportional in strength to the magnitude of the alternating current 84. As described in more detail below, measurement of the magnetic field at magnetic field sensor 55 may enable a displacement vector including a distance and direction from the twin well to the target well to be computed.

While not depicted on FIG. 2 it will be understood that the alternating current 64 that flows along the length of the drill string 30 (including the sensor sub 52) also induces a magnetic field therein. Having the same frequency as the magnetic field 86 induced in the target well 80, this magnetic field is commonly considered to be a parasitic signal that should be removed or compensated in order to properly interpret the magnetic ranging signal. This magnetic field is commonly referred to as the sonde error or the coherent error. In general, the magnitude of the sonde error depends on the geometry of the drill string 30 (and sensor sub 52) and the electrical and magnetic properties of the material from which the drill string (and sensor sub) is fabricated. The sonde error also tends to be independent of drill string rotation.

It will be understood by those of ordinary skill in the art that the deployment depicted on FIG. 2 is merely an example for the purpose of describing the disclosed embodiments set forth herein. For example, the disclosed method embodiments are not limited to the use of an electric current generating tool including an insulating gap. In other embodiments a toroid deployed about the drill string or an electromagnetic antenna may alternatively be used to induce an electric current in the target well casing. An induction device such as disclosed in U.S. Patent Publication 2012/0109527 may also be utilized. Moreover, as depicted on FIG. 1, an AC magnetic source 88 may be deployed in the target well 80.

In the depicted embodiment, sensor sub body may be threadably connected with the drill bit 32 and therefore configured to rotate with the bit 32. The depicted sensor sub 52 includes a tri-axial (three axis) accelerometer set 55 and a tri-axial magnetometer set 57. In the depicted embodiment, the sensors 55 and 57 being deployed in the a near bit sensor sub may be deployed close to the drill bit 32, for example, within two meters, or even within one meter of the bit 32. However, it will be understood that the disclosed embodiments are not limited to the use of a near-bit sensor sub or to the deployment of the sensor close to the bit. Substantially any suitable measurement tool (such as a conventional MWD tool) including a magnetic field sensor may be utilized.

Suitable accelerometers and magnetometers for use in sensors 55 and 57 may be chosen from among substantially any suitable commercially available devices known in the art. For example, suitable accelerometers may include Part Number 979-0273-001 commercially available from Honeywell, and Part Number JA-5H175-1 commercially available from Japan Aviation Electronics Industry, Ltd. (JAE). Suitable accelerometers may alternatively include micro-electro-mechanical systems (MEMS) solid-state accelerometers, available, for example, from Analog Devices, Inc. (Norwood, Mass.). Such MEMS accelerometers may be used for certain near bit sensor sub applications since they tend to be shock resistant, high-temperature rated, and inexpensive. Suitable magnetic field sensors may include conventional ring core flux gate magnetometers or conventional magnetoresistive sensors, for example, Part Number HMC-1021D, available from Honeywell.

FIG. 2 further includes a diagrammatic representation of the tri-axial accelerometer and tri-axial magnetometer sensor sets 55 and 57. By tri-axial it is meant that each sensor set includes three mutually perpendicular sensors, the accelerometers being designated as Aₓ, A_{y}, and A_{z} and the magnetometers being designated as Bₓ, B_{y}, and B_{z}. In the present application, a right handed system is designated in which the x-axis accelerometer and magnetometer (Aₓ and Bₓ) are oriented substantially parallel with the borehole as indicated (although disclosed embodiments are not limited by such conventions). Each of the accelerometer and magnetometer sets may therefore be considered as determining a transverse cross-axial plane (the y and z-axes) and an axial pole (the x-axis along the axis of the BHA).

By further convention, the gravitational field is taken to be positive pointing downward (i.e., toward the center of the Earth) while the magnetic field is taken to be positive pointing towards magnetic north. Moreover, also by convention, the y-axis is taken to be the toolface reference axis (i.e., gravity toolface T equals zero when the y-axis is uppermost and magnetic toolface M equals zero when the y-axis is pointing towards the projection of magnetic north in the transverse (yz) plane). Those of ordinary skill in the art will readily appreciate that the magnetic toolface M is projected in the yz plane and may be represented mathematically as: tan M=B_{z}/B_{y}. Likewise, the gravity toolface T may be represented mathematically as: tan T=−A_{z}/−A_{y}. Those of skill in the art will understand that the negative sign in the gravity toolface expression arises owing to the convention that the gravity vector is positive in the downward direction while the toolface reference direction is the high side of the borehole (the side facing upward).

It will be understood that the disclosed embodiments are not limited to the above described conventions for defining the borehole coordinate system. It will be further understood that these conventions can affect the form of certain of the mathematical equations that follow in this disclosure. Those of ordinary skill in the art will be readily able to utilize other conventions and derive equivalent mathematical equations.

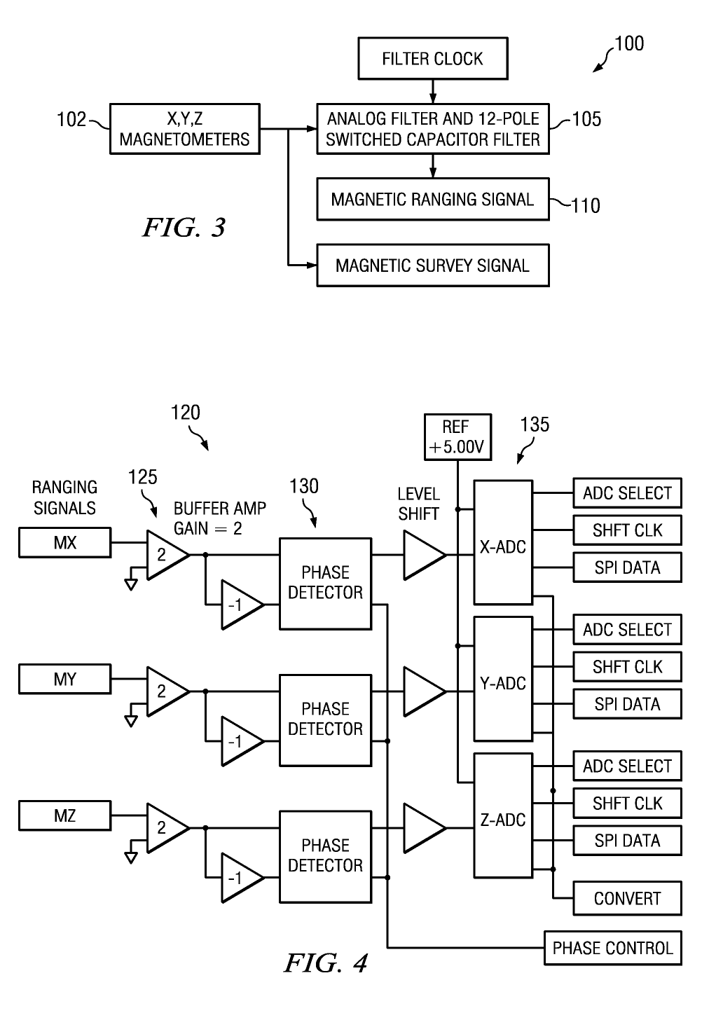

The magnetic field sensors 55 may be configured such that a single magnetometer package (a triaxial magnetometer set) may be used to acquire data from both the Earth's magnetic field and the AC target magnetic field. FIG. 3 depicts an analog circuit 100 for separating various components of the magnetometer output (the measured magnetic field that includes both the AC ranging signal and the earth's magnetic field). The depicted analog circuit 100 includes an analog filter and a 12-pole switched capacitor filter 105 that functions as a high-Q bandpass filter that removes the low-frequency baseband signal (e.g., the signal below 5 Hz). The magnetometer output 102 (the magnetometer measurements obtained during a ranging operation) is filtered at 105 to obtain the ranging signal 110. The magnetometer output may be time averaged, for example, (not shown in FIG. 3) or low pass filtered to obtain the earth's magnetic field.

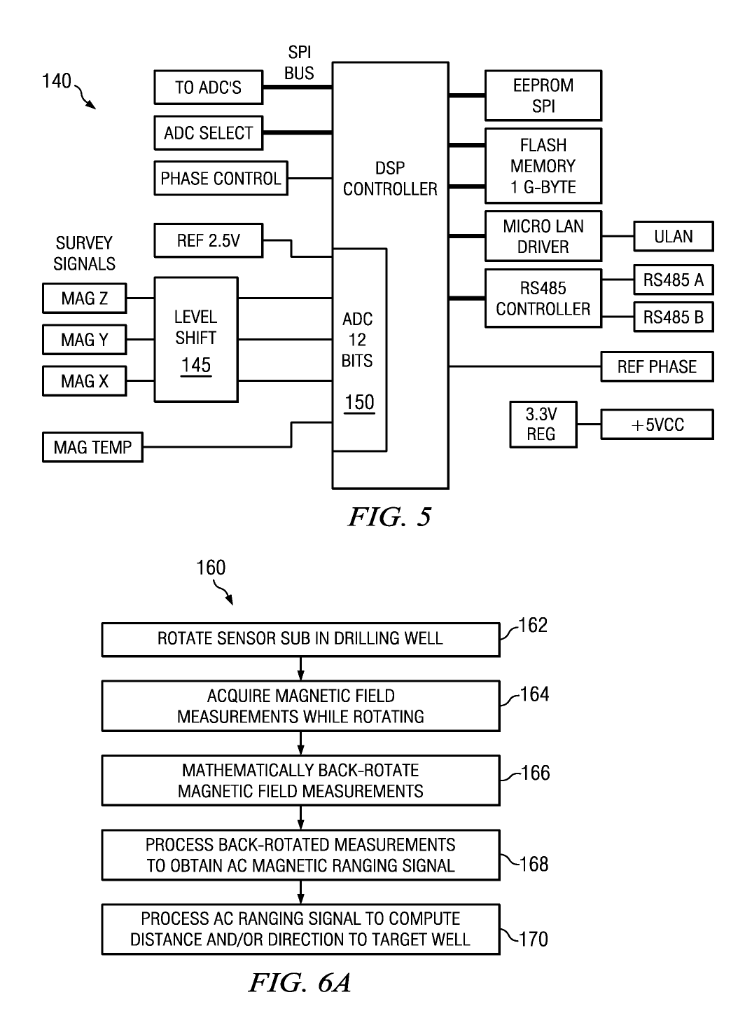

FIGS. 4 and 5 depict circuits 120 and 140 for phase sensitive detection (PSD) and the A/D conversion of the AC ranging signal and the survey signal. Circuit 120 includes buffer amplification 125 and level shift 130 functionality prior to the A/D conversion at 135. In embodiments in which the ranging signal is generated via producing an axial current in the target well casing, the ranging signals may optionally be processed using the PSD. In embodiments in which the target includes an AC magnetic field (e.g., via a solenoid source) the circuit 120 does not generally use the PSD. Circuit 140 includes level shift 145 functionality prior to the A/D conversion at 150 on a DSP (digital signal processor) controller.

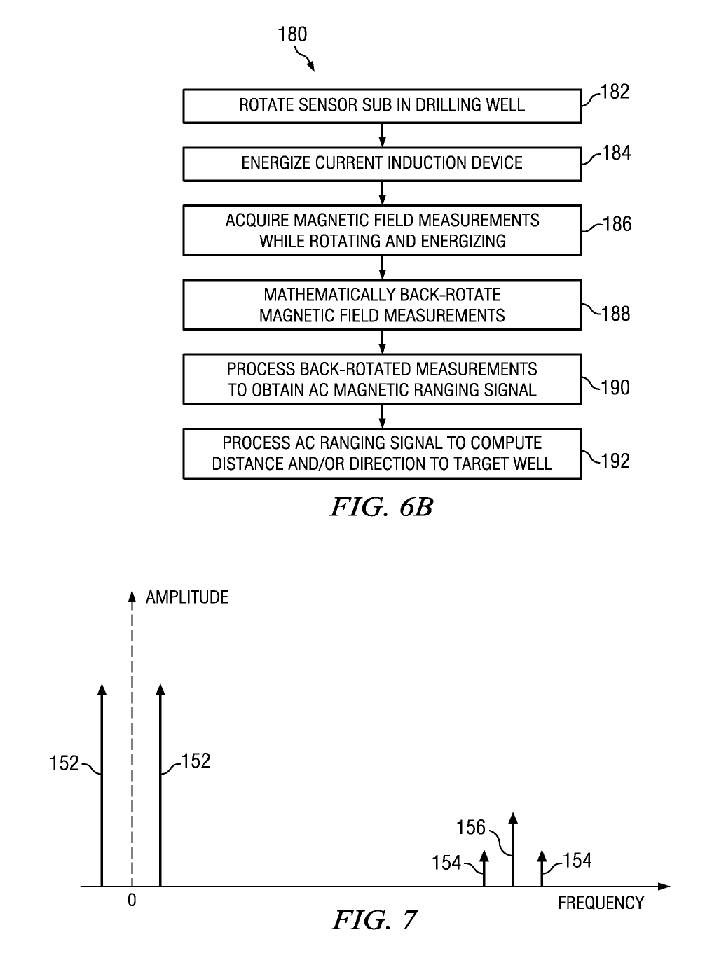

FIG. 6A depicts a flow chart of one disclosed method embodiment 160. A drill string (e.g., drill string 30) including a sensor sub (e.g., sub 52) having magnetic field sensors is rotated in a drilling well at 162 in sensory range of AC magnetic flux emanating from a target wellbore. The magnetic flux may emanate, for example, from a solenoid deployed in the target well and energized by an alternating current. Alternatively, an induced alternating current in the target well casing may cause the AC magnetic flux to emanate therefrom. Magnetic field measurements (e.g., magnetometer measurements) are acquired at 164 while rotating in 162. The acquired magnetic field measurements are mathematically rotated (back-rotated) using an inverse toolface rotation matrix at 166 to obtain rotated (back-rotated) magnetic field measurements. The rotated magnetic field measurements are processed at 168 to obtain a measurement of the AC magnetic flux emanating from the target well (also referred to herein as the ranging signal or the AC ranging signal) which is in turn further processed at 170 to obtain a distance from the drilling well to the target well.

FIG. 6B depicts a flow chart of another disclosed method embodiment 180. A drill string (e.g., drill string 30) including a sensor sub (e.g., sub 50) having magnetic field sensors and a current induction device (e.g., tool 60) is rotated in a drilling well at 182. The current induction device is energized at 184 so as to induce an alternating current in a target well casing thereby causing the target well casing to emanate AC magnetic flux. Magnetic field measurements (e.g., magnetometer measurements) are acquired at 186 while rotating in 182 and energizing in 184. The acquired magnetic field measurements are mathematically rotated (back-rotated) using an inverse toolface rotation matrix at 188 to obtain rotated (back-rotated) magnetic field measurements. The rotated magnetic field measurements are processed at 190 to obtain a measurement of the AC magnetic flux emanating from the target well (also referred to herein as the ranging signal or the magnetic ranging signal) which is in turn further processed at 192 to obtain a distance from the drilling well to the target well.

During a magnetic ranging operation, the magnetometer output (the magnetometer measurements acquired at 164 and 186) may be expressed mathematically as the combination of the following elements, for example, as follows:

\vec{MAGout}=Rtf*[Rincl*Razi \vec{M}+\vec{Br}]+\vec{Bse} (1)

where \vec{MAGout} represents the triaxial magnetometer vector output, Rtf, Rincl, and Razi represent the toolface, inclination, and azimuth rotation matrices given below in equations 2, 3, and 4, \vec{M} represents the magnetic field vector of the earth, \vec{Br} represents the AC ranging signal, and \vec{Bse} represents the sonde error (in embodiments that make use of an induced magnetic field). The toolface, inclination, and azimuth rotation matrices may be given, for example, as follows:

$$\begin{matrix}Rtf = [ \begin{matrix}1 & 0 & 0 \\ 0 & cos ( TF ) & - sin ( TF ) \\ 0 & sin ( TF ) & cos ( TF )\end{matrix} ] & ( 2 ) \\ Rincl = [ \begin{matrix}cos ( incl ) & 0 & sin ( incl ) \\ 0 & 1 & 0 \\ - sin ( incl ) & 0 & cos ( incl )\end{matrix} ] & ( 3 ) \\ Razi = [ \begin{matrix}cos ( azi ) & - sin ( azi ) & 0 \\ sin ( azi ) & cos ( azi ) & 0 \\ 0 & 0 & 1\end{matrix} ] & ( 4 )\end{matrix}$$

where the x-axis represents the toolface rotation axis, the y-axis represents the inclination rotation axis, and the z-axis represents the azimuth rotation axis.

As indicated in Equation 1, the magnetometer output (the measured ranging signal) includes a mixture of the earth's magnetic field (which may have a magnitude on the order of 50,000 nanoTesla) and the AC ranging signal (which may have a magnitude, for example, in a range from about 0.5 to about 2000 nanoTesla depending on various factors including the distance between the drilling and target wells). The AC ranging signal may have substantially any suitable frequency, for example, in the range from about 5 to about 50 Hz (e.g., 10 to 20 Hz). The magnetometer output may be further offset by a sonde error having a frequency similar to that of the AC ranging signal. The mixed-signal is further quasi-modulated by the rotation of the drill string, which is not necessarily constant during drilling (those of ordinary skill will readily appreciate the drill string rotation rates can vary significantly from their nominal values, for example due to stick slip and other torsional vibration modes).

In embodiments utilizing a near-bit sensor sub (e.g., as depicted on FIG. 2) the axial magnetometer measurements may be contaminated by remanent and induced magnetic interference from nearby ferromagnetic drilling tool components (which are not included in Equation 1). Such magnetic interference may be removed, for example, as described in U.S. Patent Publication 2013/0069655 (which is incorporated by reference in its entirety herein).

As described above, the AC ranging signal \vec{Br} may be generated via one of two methods: (i) a magnetic field resulting from an axial current flow in the target well casing (referred to herein as the gap method) or (ii) an AC magnetic source in the target well (referred to herein as the solenoid method). In the gap method, \vec{Br} May be expressed, for example, as follows (assuming that the drilling well and the target well are essentially parallel):

$$\vec{Br} = ( \begin{matrix}0 \\ Bry \\ Brz\end{matrix} ) \qquad ( 5 )$$

The sonde error \vec{Bse} (also referred to as the coherent noise) may be expressed similarly, for example, as follows:

$$\vec{Bse} = ( \begin{matrix}0 \\ Bsey \\ Bsez\end{matrix} ) \qquad ( 6 )$$

In the solenoid method, \vec{Br} May be expressed, for example, as follows (assuming that the drilling well and the target well are essentially parallel):

$$\vec{Br} = ( \begin{matrix}Brx \\ Bry \\ Brz\end{matrix} ) \qquad ( 7 )$$

In the solenoid method the sonde error \vec{Bse} is non-existent such that:

$$\vec{Bse} = ( \begin{matrix}0 \\ 0 \\ 0\end{matrix} ) \qquad ( 8 )$$

Magnetic field measurements may be made (and thus magnetic ranging measurements acquired) while the drill string is either rotating or non-rotating (e.g., sliding or stationary) in the drilling well. When the drill string is non-rotating, the toolface angle is constant such that the Earth's magnetic field is static with respect to the borehole reference frame (assuming that the azimuth and inclination are constant). The magnetometer output may be expressed mathematically, for example, as follows (following Equation 1):

$$\begin{matrix}\vec{MAGout} = Rtf * Rincl * Razi \vec{M} + Rtf * \vec{Br} + \vec{Bse} \\ = \vec{Mstat} + \vec{Br\_stat} + \vec{Bse}\end{matrix} \qquad ( 9 )$$

where \vec{Mstat} represents the static magnetic field of the earth and \vec{Br_stat} represents the static AC magnetic field from the target well. It will be understood that \vec{Br_stat} is small compared to \vec{Mstat} and is a combination of the original ranging signal components of the toolface rotation matrix such that:

Br_stat_x=Brx

Br_stat_{—}y=cos(TF)*Bry−sin(TF)Brz

Br_stat_{—}z=sin(TF)*Bry+cos(TF)Brz (10)

where Br_stat_x, Br_stat_y, and Br_stat_z represent the x-, y-, and z-axis components of \vec{Br_stat}. In the gap method, Brx is generally equal to zero since the drilling well is essentially parallel to the target well. U.S. Patent Publications 2011/0278067 and 2011/0282583 (which are incorporated by reference in their entirety herein) disclose methods for overcoming the coupling of the ranging components in the sonde error by acquiring magnetic ranging measurements at least four distinct toolface values. In the solenoid method, Brx is a maximum when the solenoid is adjacent to (axially aligned with) the magnetic field sensors.

When the drill string is rotating, the azimuth and inclination may be assumed to be constant while the toolface angle varies with rotation. The magnetometer output may be expressed mathematically, for example, as follows (following Equation 1):

$$\begin{matrix}\vec{MAGout} = Rtf * Rincl * Razi \vec{M} + Rtf * \vec{Br} + \vec{Bse} \\ = \vec{Mrot} + \vec{Br\_rot} + \vec{Bse}\end{matrix} \qquad ( 12 )$$

where \vec{Mrot} represents the rotating magnetic field of the earth and \vec{Br_rot} represents the rotating AC magnetic field from the target well. It will be understood that \vec{Br_rot} is small compared to \vec{Mrot} and is a combination of the original ranging signal components of the toolface rotation matrix such that:

Br_rot_x=Brx

Br_rot_{—}y=cos(TF)*Bry−sin(TF)Brz

Br_rot_{—}z=sin(TF)*Bry+cos(TF)Brz (13)

where Br_rot_x, Br_rot_y, and Br_rot_z represent the x-, y-, and z-axis components of \vec{Br_rot}. Rotation of the drill string (and the corresponding variation in toolface angle) create upper and lower side bands for both the earth's magnetic field and the ranging magnetic field in a magnetic field amplitude spectrum. FIG. 7 depicts one example of a magnetic field amplitude spectrum including side bands. Note that the magnetic field of the earth \vec{Mrot} and the ranging magnetic field \vec{Br_rot} are split into upper and lower side bands as indicated at 152 and 154 (where the frequency of the upper side bands 154 minus the frequency of the lower sideband 152 is twice that of the rotation rate of the drill string). The sonde error \vec{Bse} (when using the gap method) remains unaffected as indicated at 156. It will be understood that the relative amplitudes are not drawn to scale (e.g., \vec{Mrot} may be 100 or more times greater than \vec{Br_rot} while \vec{Bse} may also be significantly greater than \vec{Br_rot}).

With reference again to FIGS. 6A and 6B, the rotating ranging signals may be decoupled (at 166 and 188) by applying an inverse toolface rotation matrix to the magnetometer output. This may be expressed mathematically, for example, as follows:

$$\begin{matrix}\vec{{MAG}_{decoupled}} = {R}^{- 1} tf * \vec{MAGout} \\ = Rincl * Razi \vec{M} + \vec{Br} + {R}^{- 1} tf * \vec{Bse} \\ = \vec{Mstat} + \vec{Br} + \vec{Bse\_rot}\end{matrix} \qquad ( 14 )$$

where the inverse toolface rotation matrix R⁻¹tf is given as follows:

$${R}^{- 1} tf = [ \begin{matrix}1 & 0 & 0 \\ 0 & cos ( TF ) & sin ( TF ) \\ 0 & - sin ( TF ) & cos ( TF )\end{matrix} ] \qquad ( 15 )$$

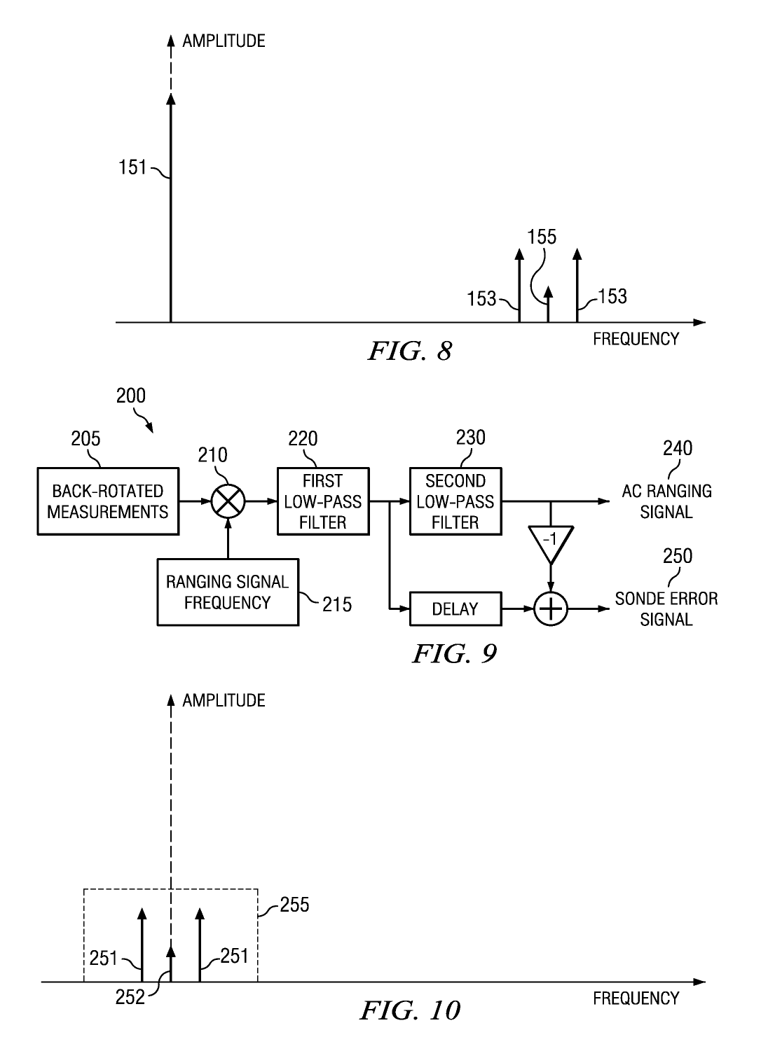

FIG. 8 depicts one example of a magnetic field amplitude spectrum after application of an inverse toolface rotation matrix to the magnetometer output (e.g., as expressed in equation 14). Note that the Earth's magnetic field \vec{Mstat} is independent of rotation (and without side bands) as indicated at 151. The ranging signal Br is centered at the frequency of the magnetic field source (e.g., 20 Hz) as indicated at 155. The sonde error is modulated in that it is split into upper and lower side bands (when the gap method is used) as indicated at 153. The sonde error is zero when the solenoid method is used. It will be understood that although the drill string is rotating, both the Earth's total magnetic field and the ranging signal energies are constant. Again, as described above, the relative amplitudes are not drawn to scale. It will be further understood that the rotation decoupling (the application of the inverse toolface rotation matrix) may be handled by a downhole processor after a data acquisition sequence is completed (e.g., at 10 second or 60 second intervals) since both the ranging and survey signals are acquired simultaneously stored tool memory.

It will be understood that the earth's magnetic field may be extracted using analog or digital techniques. Example analog techniques are described above with respect to FIG. 3. One or more digital filters may also be similarly employed. While it is by no means necessary to use analog filters (as described in FIG. 3) it may be advantageous due to the relative size of the earth's field as compared to the ranging signal.

After the rotation decoupling (the back-rotating) described above the original ranging signal \vec{Br} may be extracted (e.g., using software or tool firmware), for example, by multiplying \vec{MAG_{decoupled}} by a waveform having the ranging signal frequency, e.g., by cos(ωt+φ), where ω equals 2πf, with f representing the frequency of the AC ranging signal (e.g., 20 Hz). Other methodologies may also be employed.

Digital signal processing techniques may be employed to separate the ranging signal from the sonde error signal and the earth's magnetic field if so desired. FIG. 9 depicts a block diagram 200 of one example technique for processing the decoupled rotating ranging signals. The decoupled (back-rotated) measurements 205 are multiplied by the ranging signal frequency 215, e.g., by cos(ωt+φ), at 210 so as to split \vec{MAG_{decoupled}} into first and second signal components at corresponding first and second frequencies (the first frequency being the difference between the frequency of the measured signal and the AC ranging signal (which is approximately zero) and the second frequency being the sum of the measured signal and the AC ranging signal (which is about twice that of the ranging signal frequency).

The first low pass filter 220 is intended to remove undesirable signals such as the second signal generated at 210 such that only the first signal generated at 210 is retained (which includes components from both the AC ranging signal and the sonde error). Low pass filter 220 may also be used to remove the magnetic field of the earth if so desired. A second low pass filter 230 is then applied to remove the sonde error leaving only the AC ranging signal at 240. The outputs of the first and second low pass filters 220 and 230 may be further processed at 250 to obtain the sonde error signal.

It will be understood that the earth's magnetic field may be removed at different places in the process flow (e.g., at analog filter 105 in FIG. 3, at low pass filter 220 in FIG. 9, or using a digital bandpass filter before or after 205 in FIG. 9). It will further be understood that there is a tradeoff between an acceptable delay and desirable accuracy. In general the analog filter depicted on FIG. 3 provides the best accuracy.

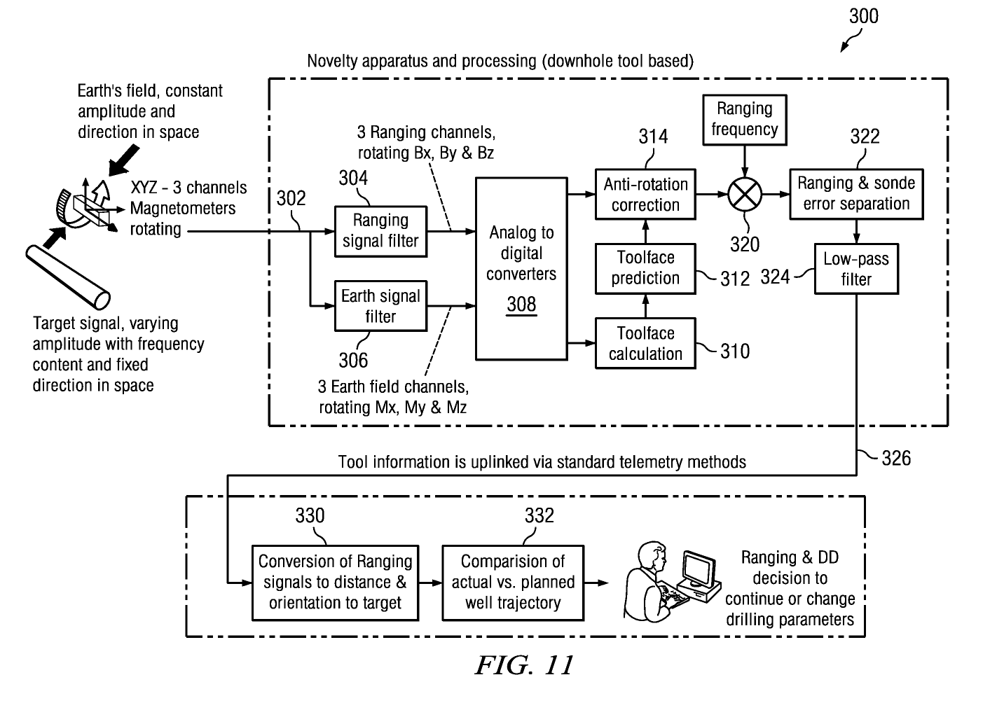

FIG. 10 depicts one example of a magnetic field amplitude spectrum obtained after applying the first low pass filter 220 in FIG. 9. Note that the only signal components that remain are the AC ranging signal Br 252 and the modulated sonde error \vec{Bse_rot} 251. The AC ranging signal Br is centered at about 0 Hz (the frequency difference between the AC ranging signal in the measured signal). The passband of the first low pass filter is schematically depicted at 255. The modulated sonde error \vec{Bse_rot} 251 is offset from the AC ranging signal 252 by the rotation rate of the drill string (which is typically in a range from about 1-4 Hz). The second low pass filter 230 may have a passband of less than the rotation rate of the drill string (e.g., 0.5 Hz) so as to fully remove the modulated sonde error.

It will be understood that the first and second low pass filters may introduce a phase shift between the input and output ranging signals (i.e., between the real ranging signal and the output ranging signal). It will be further understood that the phase shift tends to vary with temperature and frequency and may affect the phase between the toolface and output ranging signal. Downhole firmware may be utilized to compensate for such a phase shift. For example, the low pass filter characteristics may be measured and recorded in the downhole tool memory such that the downhole firmware may compensate for the phase shift.

FIG. 11 depicts a block diagram of another disclosed method embodiment 300. Triaxial magnetometer measurements (three channel) are received at 302. The measurements are processed using analog filters at 304 and 306 to obtain a three channel ranging signal (Bₓ, B_{y}, and B_{z}) and a three channel earth's field signal (Mₓ, M_{y}, and M_{z}). Although not depicted, a narrow band amplification may optionally be performed on the signal after filtering at 304. Filter 304 may include, for example, an analog filter such as filter 105 depicted on FIG. 3. Filter 306 may include, for example, an averaging filter or an averaging circuit. The ranging signals and Earth's field signals are digitized at 308. The digitized signals may be further processed to compute the toolface angle at 310 and a toolface prediction at 312. The digitized signals and the toolface angle are further processed (back-rotated) at 314 in combination with an inverse toolface rotation matrix (as described above with respect to equations 14 and 15) to decouple the drill string rotation from the AC ranging signal.

The decoupled measurements may then be multiplied by a waveform having the ranging signal frequency (e.g., by cos(ωt+φ) as described above) at 320 to frequency separate the AC ranging signal from the sonde error as indicated at 322. The AC ranging signal they be isolated via further low pass filtering at 324 as described above with respect to FIG. 9. The isolated AC ranging signal may then be transmitted (uplinked) to the surface at 326 using conventional telemetry methods (e.g., via mud pulse, mud siren, and/or wire drill pipe). The AC ranging signal may then be further processed at the surface at 330 to obtain at least one of a distance and a direction from the drilling well to the target well. The distance and/or the direction may be in turn compared with a planned well trajectory and further processed at 332 to obtain a subsequent direction of drilling of the drilling well (e.g., to change or otherwise correct the direction of drilling or to maintain the current direction of drilling).

It will be understood that since the tool is rotating that the measured toolface angle may not be current (at the time of applying the anti-rotation correction). Thus a predictor may be used at 312 to correct the phase of the ranging signal and the phase of the toolface. Predictors, such as such as an autoregressive moving average (ARMA) filter or a Klaman filter may be used to estimate the phase between the ranging signal and the toolface. Such corrections may be easily implemented in the firmware as desired.

It will be understood that the foregoing discussion has assumed that the AC magnetic field emanating from the target is substantially sinusoidal. However, the disclosed embodiments are not limited in this regard as in practice, the measured magnetic field may be not perfectly sinusoidal. For example, nonlinear behavior of ferromagnetic materials in the solenoid core (when using the solenoid method) and/or in the casing may cause the emitted AC magnetic field to be non-sinusoidal. Such nonlinear behavior may cause the magnetic field to contain a third harmonic corresponding to a depression of the peak values resulting from material nonlinearity as magnetic saturation is approached. Corrections for harmonics (such as the above described third harmonic) may be made by modeling their effect or by experiments conducted at the surface. Alternatively, the solenoid may be driven by a non-sinusoidal current whose waveform is adjusted to produce a sinusoidal magnetic field at the receiver. The necessary waveform may be determined by modeling, by experiments conducted at the surface, or by feedback from real-time measurements of the received magnetic waveforms. The disclosed embodiments are not limited in this regard.

It will be understood that while not shown in FIGS. 1 and 2, downhole measurement tools suitable for use with the disclosed embodiments generally include at least one electronic controller. Such a controller may include signal processing circuitry including a digital processor (a microprocessor), various filtering and amplification circuitry, an analog to digital converter, and processor readable memory. The controller typically also includes processor-readable or computer-readable program code embodying logic, including instructions for computing various parameters as described above, for example, with respect to the disclosed mathematical equations. One skilled in the art will also readily recognize some of the above mentioned equations may also be solved using hardware mechanisms (e.g., including analog or digital circuits).

A suitable controller typically includes a timer including, for example, an incrementing counter, a decrementing time-out counter, or a real-time clock. The controller may further include multiple data storage devices, various sensors, other controllable components, a power supply, and the like. The controller may also optionally communicate with other instruments in the drill string, such as telemetry systems that communicate with the surface or an EM (electro-magnetic) shorthop that enables the two-way communication across a downhole motor. It will be appreciated that the controller is not necessarily located in the sensor sub (e.g., sub 60), but may be disposed elsewhere in the drill string in electronic communication therewith. Moreover, one skilled in the art will readily recognize that the multiple functions described above may be distributed among a number of electronic devices (controllers).

Although magnetic ranging while rotating and certain advantages thereof have been described in detail, it should be understood that various changes, substitutions and alternations can be made herein without departing from the spirit and scope of the disclosure as defined by the appended claims.

What is claimed is:

1. A method for magnetic ranging comprising:
(a) rotating a downhole drilling tool in a drilling well in sensory range of an AC magnetic ranging signal emanating from a target well, the drilling tool including a magnetic field sensor rotatably coupled to the tool;
(b) causing the magnetic field sensor to obtain a plurality of magnetic field measurements while rotating in (a);
(c) mathematically back-rotating the magnetic field measurements obtained in (b) to obtain back-rotated magnetic field measurements;
(d) processing the back-rotated magnetic field measurements to obtain a measurement of the AC magnetic ranging signal emanating from the target well; and
(e) processing the measurement of the AC magnetic ranging signal obtained in (d) to compute at least one of a distance and a direction from the drilling well to the target well.

2. The method of claim 1, wherein the magnetic field measurements obtained in (b) are mathematically back-rotated in (c) via matrix multiplication in which the magnetic field measurements are multiplied by an inverse toolface rotation matrix.

3. The method of claim 1, wherein the magnetic field sensor comprises a tri-axial set of magnetometers and each of the magnetic field measurements comprises a three-dimensional magnetic field vector.

4. The method of claim 3, wherein the magnetic field vector is mathematically back-rotated in (c) using the following mathematical equation:
\vec{MAG_{decoupled}}=R⁻¹tf*\vec{MAGout}
wherein \vec{MAG_{decoupled}} represents the back-rotated magnetic field measurements, \vec{MAGout} represents the magnetic field vector measured in (b); and R⁻¹tf represents an inverse toolface rotation matrix.

5. The method of claim 4, wherein the back-rotated magnetic field measurements are mathematically related to the AC magnetic ranging signal as follows:
\vec{MAG_{decoupled}}=Rincl*Razi \vec{M}+\vec{Br}+R⁻¹tf*\vec{Bse}
wherein \vec{M} represents the earth's magnetic field, \vec{Br} represents the AC magnetic ranging signal, \vec{Bse} represents a sonde error, Rincl represents an inclination rotation matrix, and Razi represents and azimuth rotation matrix.

6. The method of claim 4, wherein the inverse toolface rotation matrix is expressed mathematically as follows:
$${R}^{- 1} tf = [ \begin{matrix}1 & 0 & 0 \\ 0 & cos ( TF ) & sin ( TF ) \\ 0 & - sin ( TF ) & cos ( TF )\end{matrix} ]$$
wherein TF represents a magnetic toolface derived from the magnetic field vector measured in (b).

7. The method of claim 1, wherein the AC magnetic ranging signal obtained in (d) is transmitted to a surface location and the processing in (e) is performed at the surface location.

8. The method of claim 7, further comprising:
(f) further processing the distance and the direction to obtain a direction for subsequent drilling of the drilling well.

9. The method of claim 1, wherein the AC magnetic ranging signal is generated by a solenoid deployed in the target well.

10. The method of claim 1, wherein the AC magnetic ranging signal is generated by a current induction device in the drilling well that induces an alternating current in a casing string deployed in the target well.

11. The method of claim 1, wherein (d) further comprises:
(i) multiplying the back-rotated magnetic field measurements by a waveform having a frequency equal to that of the AC magnetic ranging signal to obtain a signal including first and second signal components; and
(ii) processing the signal including first and second signal components to obtain the AC magnetic ranging signal.

12. The method of claim 11, wherein the waveform is expressed mathematically as cos(ωt+φ), wherein ω=2πf with f being frequency and φ being phase.

13. The method of claim 1, wherein (b) and (c) in combination comprise:
(i) causing the magnetic field sensor to obtain a plurality of magnetic field measurements while rotating in (a);
(ii) filtering the plurality of magnetic field measurements using an analog bandpass filter to remove an earth's magnetic field component and obtain filtered magnetic field measurements;
(iii) digitizing the filtered magnetic field measurements to obtain digitized measurements; and
(iv) mathematically back-rotating the digitized measurements obtained in (iii) to obtain the back-rotated magnetic field measurements.

14. A method for magnetic ranging comprising:
(a) rotating a downhole drilling tool in a drilling well, the downhole tool including a magnetic field sensor rotatably coupled to the tool and a current induction device;
(b) energizing the current induction device thereby causing a casing string deployed in the target well to emanate an AC magnetic ranging signal;
(c) causing the magnetic field sensor to obtain a magnetic field measurement while rotating in (a) and energizing in (b);
(d) mathematically back-rotating the magnetic field measurements obtained in (c) via matrix multiplication in which the magnetic field measurements are multiplied by an inverse toolface rotation matrix to obtain back-rotated magnetic field measurements.
(e) processing the back-rotated magnetic field measurements to obtain a measurement of the AC magnetic ranging signal emanating from the target well; and
(f) processing the measurement of the AC magnetic ranging signal obtained in (d) to compute at least one of a distance and a direction from the drilling well to the target well.

15. The method of claim 14, wherein (e) further comprises:
(i) multiplying the rotated magnetic field measurements by a waveform having a frequency equal to that of the AC magnetic ranging signal to obtain a signal including a first signal component and a second signal component;
(ii) processing the signal with a first low pass filter to remove the second signal component and obtain a filtered signal; and
(iii) processing the filtered signal with a second low pass filter to remove a sonde error signal and obtain the AC magnetic ranging signal.

16. The method of claim 14, wherein (c) and (d) in combination comprise:
(i) causing the magnetic field sensor to obtain a plurality of magnetic field measurements while rotating in (a) and energizing in (b);
(ii) filtering the plurality of magnetic field measurements using an analog bandpass filter to remove an earth's magnetic field component and obtain filtered magnetic field measurements;
(iii) digitizing the filtered magnetic field measurements to obtain digitized measurements; and
(iv) mathematically back-rotating the magnetic field measurements obtained in (c) via matrix multiplication in which the magnetic field measurements are multiplied by an inverse toolface rotation matrix to obtain the back-rotated magnetic field measurements.

17. A downhole ranging tool comprising:
a downhole tool body configured for coupling with a drill string;
a magnetic field sensor deployed in the downhole tool body;
an analog bandpass filter in electrical communication with the magnetic field sensor; and
a processor configured to (i) cause the magnetic field sensor to obtain a plurality of filtered magnetic field measurements while the downhole tool body is rotating with a drill string; (ii) mathematically back-rotate the filtered magnetic field measurements to obtain back-rotated magnetic field measurements; (iii) process the back-rotated magnetic field measurements to obtain a measurement of the AC magnetic ranging signal emanating from a nearby subterranean target well; and (iv) transmit the AC magnetic ranging signal to a surface location.

18. The downhole tool of claim 17, wherein the processing in (ii) further comprises (ii) mathematically back-rotate the filtered magnetic field measurements via matrix multiplication in which the magnetic field measurements are multiplied by an inverse toolface rotation matrix to obtain back-rotated magnetic field measurements.

19. The downhole tool of claim 17, wherein the processing in (iii) further comprises:
(iiia) multiplying the rotated magnetic field measurements by a waveform having a frequency equal to that of the AC magnetic ranging signal to obtain a signal including a first signal component and a second signal component; and
(iiib) processing the signal with a first low pass filter to remove the second signal component and obtain a filtered signal; and
(iiib) processing the filtered signal with a second low pass filter to remove a sonde error signal and obtain the AC magnetic ranging signal.
